(19) United States
(12) Patent Application Publication
(10) Pub. No.: US 2008/0106886 A1
(43) Pub. Date: May 8, 2008

(54) Apparatus for controlling swivel angles of on-vehicle headlights

(76) Inventors: Toshio Sugimoto, Okazaki-shi (JP); Koji Ishiguro, Toyoake-shi (JP)

Correspondence Address: HARNESS, DICKEY & PIERCE, P.L.C., P.O. BOX 828, BLOOMFIELD HILLS, MI, 48303, US

(21) Appl. No.: 11/980,178

(22) Filed: Oct. 30, 2007

(30) Foreign Application Priority Data
Oct. 31, 2006 (JP) 2006-295284

(51) Int. Cl. B60Q 1/00

(52) U.S. Cl. 362/37

(57) ABSTRACT

An apparatus controls a swivel angle of headlight mounted on a vehicle, wherein the swivel angle of the lights is changeable in a lateral direction of the vehicle. In the apparatus, road curvature information is acquired on a curvature of a road in front of a vehicle and a driving mechanism which rotationally changes the swivel angle of the headlights is controlled based on the road curvature information. Further, it is judged whether or not an oncoming vehicle is present. The swivel angle is limited within a predetermined limit angle range which prevents a driver of the oncoming vehicle from being dazzled, in a case where it is judged that the oncoming vehicle is present on a road lane to which the headlights are swiveled.

### CROSS-REFERENCE TO RELATED APPLICATION

This application is based on and claims the benefit of priority from earlier Japanese Patent Application No. 2006-295284 filed Oct. 31, 2006, the description of which is incorporated herein by reference.

### BACKGROUND OF THE INVENTION

1. Technical Field of the Invention

The present invention relates to an apparatus for controlling swivel angles of headlights mounted on a vehicle (a headlight swivel control apparatus), which controls a swivel angle of headlights which are mounted on the front a vehicle in a horizontal plane to the vehicle body.

2. Description of the Related Art

A headlight swivel control apparatus for controlling a swivel angle of headlights to an angle corresponding to a curvature of a road in front of a vehicle by controlling a driving device for headlights is known. Even when the vehicle is running on a curved road or even in a case where a curved road is present in front of the vehicle, the headlight swivel control apparatus enables making an area illuminated by the headlights closer to the visible direction of the driver by changing the swivel angle of the headlights according to the curvature of the road in front of the vehicle.

As a headlight swivel, control apparatus as described above, a device for determining a curvature of a road in front of a vehicle based on a steering angle is known. Furthermore, as disclosed in Japanese Patent Application (unexamined) No. 2003-48481, a device for acquiring information on a curvature of a road in front of a vehicle from a navigation apparatus is also known.

Generally speaking, since the former method is capable of more accurately judging a road curvature, a steering angle swivel control based on a steering angle is executed when it can be judged that steering operation has been performed. Meanwhile, a collaborative navigation control using road information from the navigation apparatus is executed in a case where although a curved road is present in front of the vehicle, but steering operation has been performed since the vehicle is still running on a straight road.

Meanwhile, in a case where an oncoming vehicle is present in front of the vehicle, if a swivel control is executed so that the swivel angle is changed toward the road lane of the oncoming vehicle, a light beam from the headlights may dazzle the driver of the oncoming vehicle.

### SUMMARY OF THE INVENTION

The present invention has been achieved in view of the foregoing circumstances, and an object of the present invention is to provide a headlight swivel control apparatus which is capable of preventing dazzling a driver of an oncoming vehicle.

As one aspect of the present invention, there is provided an apparatus for controlling a swivel angle of headlights mounted on a vehicle, wherein the swivel angle of the lights is changeable in a lateral direction of the vehicle. The apparatus comprises a driving mechanism that changes the swivel angle of the headlights in the lateral direction of the vehicle; road curvature information acquisition means for acquiring road curvature information on a curvature of a road in front of a vehicle; swivel control means for controlling the driving mechanism based on the road curvature information acquired by the road curvature information acquisition means; oncoming vehicle judgment means for judging whether or not an oncoming vehicle is present; and swivel angle limit means for limiting the swivel angle within a predetermined limit angle range which prevents a driver of the oncoming vehicle from being dazzled, in a case where it is judged by the oncoming vehicle judgment means that the oncoming vehicle is present on a road lane to which the headlights are swiveled.

According to this aspect of the present invention, the swivel angle is limited to within the limit angle range in a situation where it is judged by the oncoming vehicle judgment means that an oncoming vehicle is present on the road lane to which the headlights are swiveled. This enables preventing dazzling the driver of the oncoming vehicle.

### BRIEF DESCRIPTION OF THE DRAWINGS

In the accompanying drawings:

FIG. 1 is a block diagram showing a structure of a headlight apparatus for a vehicle which includes a headlight swivel controller according to an embodiment of the present invention;

FIG. 2 is a chart showing a main routine which is executed by the control apparatus for controlling a swivel angle;

FIG. 3 is a chart showing a sub routine which is executed for calculating a target swivel angle;

FIG. 4 is a chart showing a sub routine which is executed for calculating a further target swivel angle;

FIG. 5 is a chart showing a sub routine which is executed for executing an advance swivel control;

FIG. 6 is a chart showing a sub routine which is executed for executing a steering angle swivel control; and

FIG. 7 is a chart explaining the reason why the target swivel angle can be calculated with an equation.

### DESCRIPTION OF THE PREFERRED EMBODIMENT

An embodiment of the present invention will now be described with reference to the drawings.

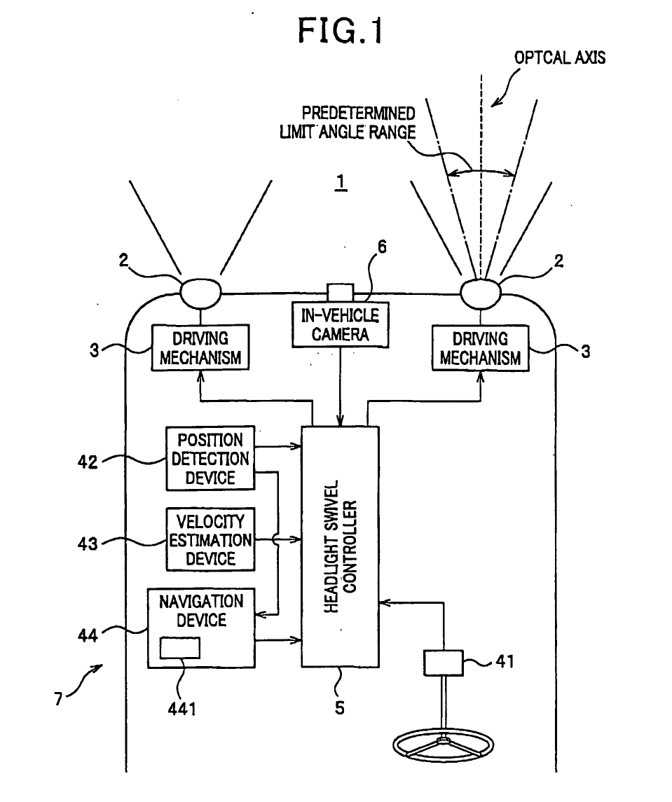

FIG. 1 is a block diagram showing a structure of a headlight apparatus 1 for a vehicle which includes a headlight swivel controller 5 (hereinafter, merely referred to as controller) according to an embodiment of the present invention. The headlight apparatus 1 corresponds to “an apparatus for controlling a swivel angle of headlights mounted on a vehicle” of the present invention.

As shown in FIG. 1, the headlight apparatus 1 for a vehicle includes a pair of headlights 2, 2 which are disposed on a front face of a vehicle 7, driving mechanisms 3, 3 which rotationally drive the headlights 2, 2 in a horizontal plane (i.e., a lateral direction of the vehicle), steering angle detection means 41 which sequentially detects a steering angle ω of the vehicle 7, position detection device 42 which sequentially detects a current position of the vehicle 7, velocity estimation device 43 which sequentially estimates a velocity V of the vehicle 7, navigation device 44, the controller, and an in-vehicle camera 6.

The driving mechanism 3 is a known mechanism which rotationally drives the headlights 2 within a predetermined angle range around a rotational axis which is perpendicular to the driving mechanism 3. The driving mechanism 3 has, for example, a structure as follows. That is, the driving mechanism 3 includes: a motor which is electrically connected to the controller and the drive thereof is controlled by the controller, a worm gear which is integrally rotated with a rotational axis of the motor, and a worm wheel which is thread-engaged with the worm gear with each other. In addition, the driving mechanism 3 is secured to the worm wheel thereof so that the rotational axis of the headlights 2 is integrally rotated with the worm wheel. The driving mechanism 3 enables adjusting a swivel angle α of the optical axis of each of the headlights 2 within a predetermined angle range (e.g., ±15 degrees). Next, the elbow point is moved by adjustment of the swivel angle α.

The steering angle detection means 41 Includes a known steering angle sensor and detects the steering angle ω.

The position detection device 42 includes a GPS receiver which sequentially receives data for position detection which have been sequentially transmitted from a plurality of GPS artificial satellites. (The data for position detection include data on the position coordinate of the artificial satellites, data on time and the like.) The position detection device 42 sequentially detects a current position X of the vehicle 7 from the data received by the GPS receiver. In addition to the GPS receiver, the position detection device 42 may include a known sensor to be used for vehicle position detection such as a geomagnetic sensor, a gyroscope sensor or the like, and may detect the position of the vehicle 7 while using them in a complementary manner.

The velocity estimation device 43 includes vehicle velocity sensors each of which is provided in each wheel and outputs a vehicle velocity pulse at an interval corresponding to rotation of the wheel. The velocity estimation device 43 sequentially calculates the velocity V of the vehicle 7 based on the vehicle velocity pulse from these vehicle velocity sensors.

The navigation device 44 includes a storage device 441 which stores road map data. The road map data stored in the storage device 441 includes node information and link information for navigation points arranged in sections which are formed by arbitrarily dividing the road in the direction of the lane. The position coordinate information and the like for each navigation point is stored as the node information, and connection information between the navigation points (a curvature R, a vector, i.e., curvature direction) and the like is stored as the link information. In addition, the navigation point which exists at the end of a curved road is set as a curved road end point. Note that the curved road refers to a road which has a curvature R which is equal to or less than a value which has been set in advance.

Next, the navigation device 44 determines which road the vehicle 7 is running from the current position X of the vehicle 7 detected by the position detection device 42 and the road map data stored in the storage device 441. In a case where a guidance route has been set, the navigation device 44 executes a predetermined guiding operation so that the vehicle 7 is running following the guidance route.

An imaging area has been set for the in-vehicle camera 6 so as to enable the in-vehicle camera 6 picking up an image of a road in front of the vehicle. The in-vehicle camera 6 picks up an image of the road in front of the vehicle ether in response to a command from the controller or in a continuous manner, and supplies the controller with a signal which represents the picked-up image of the road in front of the vehicle.

The controller is a computer which includes a central processing unit (CPU), a read only memory (ROM), a random access memory (RAM) and the like in the inside thereof, not shown. The controller controls the swivel angle α of the headlights 2 by executing programs stored in the ROM, while utilizing a temporary storage function of the RAM.

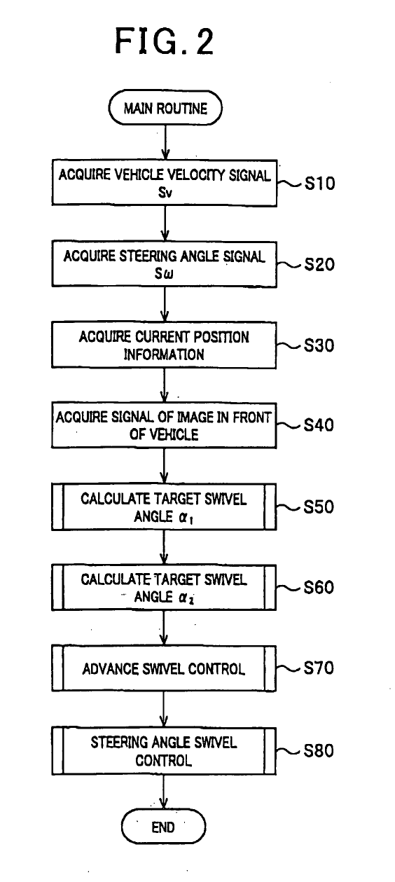

FIG. 2 shows a main routine which is executed by the controller for controlling the swivel angle α. The processing shown in FIG. 2 is repeatedly executed at a predetermined cycle.

In FIG. 2, first, at Step S10 which corresponds to the vehicle velocity signal acquisition means, a vehicle velocity signal Sv which represents the vehicle velocity V is acquired from the velocity estimation device 43. At subsequent Step 520, that is, the processing corresponding to the road curvature information acquisition means, a steering angle signal Sω which represents a steering angle ω is acquired from the steering angle detection means 41.

At the subsequent Step S30, that is, the processing corresponding to the position information acquisition means, the current position information which represents the current position X is acquired from the position detection device 42. At subsequent Step S40, the signal of the image in front of the vehicle is acquired from the in-vehicle camera 6.

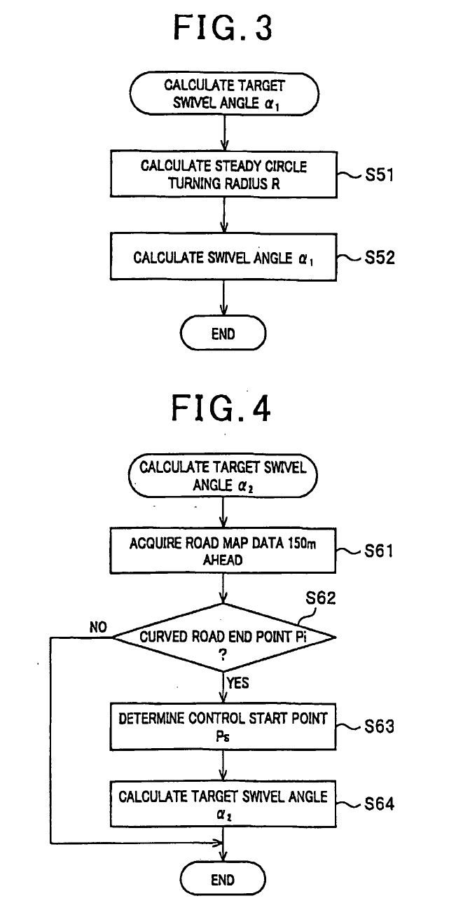

The Steps S50 to S80 to be described below are the processing corresponding to the swivel control means. At Step S50, the sub routine shown in FIG. 3 to be described later is executed, whereby a target swivel angle α₁ which serves as the target value of the swivel angle α in the steering angle swivel control is calculated. At subsequent Step S60, the sub routine shown in FIG. 4 to be described later is executed, whereby a target swivel angle α₂ which serves as the target value of the swivel angle α in the advance swivel control is calculated.

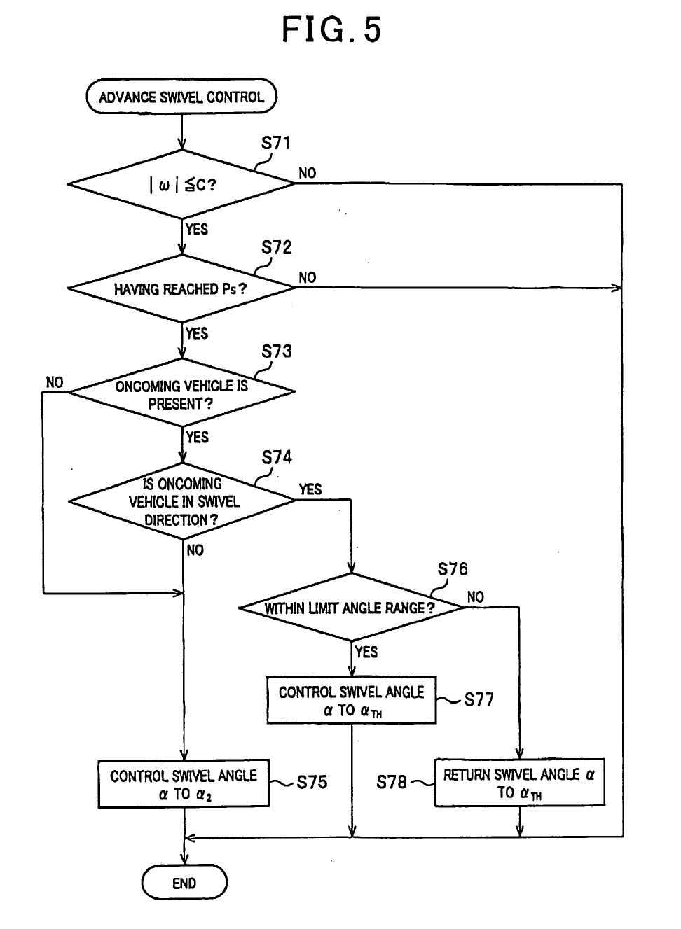

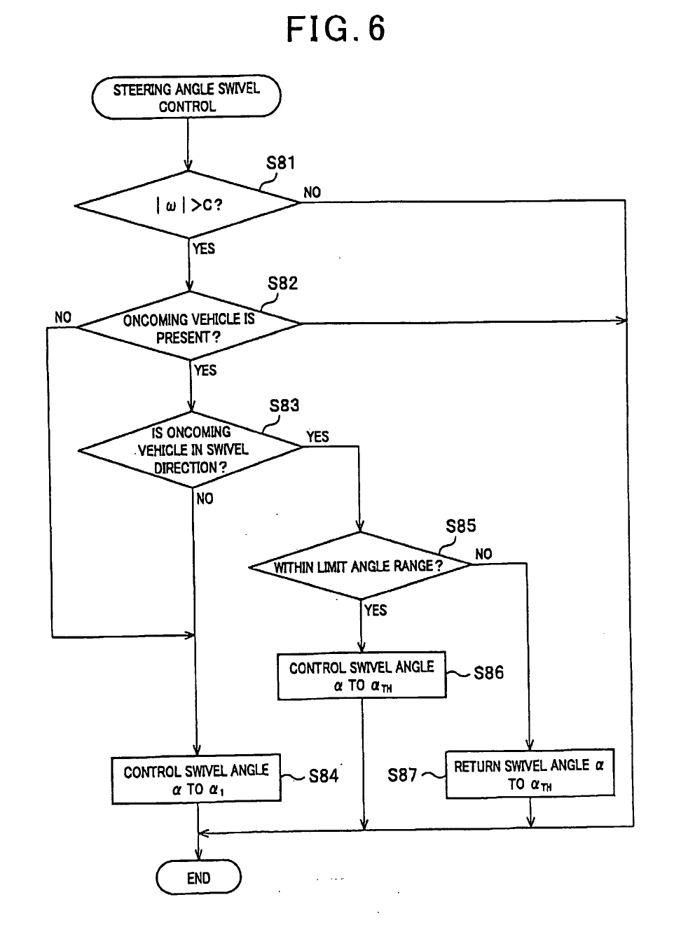

Next, at Step S70, the advance swivel control is executed by executing a sub routine shown in FIG. 5 to be described later. At Step S80, the steering angle swivel control is executed by executing a sub routine shown in FIG. 6 to be described later.

The sub routine shown in FIG. 3 for calculating the target swivel angle α₁ will now be described. In FIG. 3, first at Step S51, a steady circle turning radius R is calculated by substituting to the following Equation (1) the vehicle velocity V and the steering angle ω which are respectively represented by the vehicle velocity signal Sv and the steering angle signal Sω which are respectively acquired at Step S10 and S20 in FIG. 2:
R=(L/(ωxS))×(1+KV²) (1)
In Equation (1), L denotes the wheel base, S denotes the steering gear ratio, and K denotes the stability factor, each of which is a constant which has been set in advance.

Next, at subsequent Step S52, the target swivel angle α₁ is calculated by substituting the vehicle velocity V and the steady circle turning radius R calculated at Step S51 to the following Equation (2). Note that, in Equation (2), T denotes the light distribution point determination time and, for example, it is set to three seconds.
α₁=((TxV/2)/2nR)×360 (2)

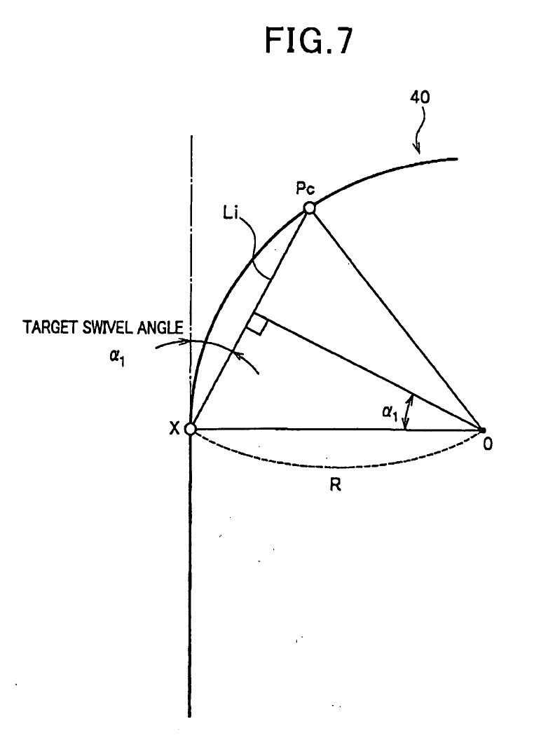

In Equation (2) as described above, TxV denotes the length of an arc on which the vehicle 7 is running along a circle having the steady circle turning radius R at the velocity V for T seconds. As shown in FIG. 7, the center angle of the arc with the length TxV/2 in the circle having the steady circle turning radius R shall become the target swivel angle α₁. Accordingly, the target swivel angle α₁ can be calculated from Equation (2) as described above.

In FIG. 7, numeral 40 denotes the actual running line of the vehicle 7. If it is assumed that the vehicle 7 is running at the velocity V, the vehicle 7 which is positioned at the current position X will be positioned substantially at a distribution point Pc T seconds later. Accordingly, the target swivel angle α1 is to be set so that an optical axis Li of the headlights 2 passes through the light distribution point Pc thereof.

The sub routine shown in FIG. 4 for calculating the target swivel angle α₂ will now be described. In FIG. 4, first at Step S61, that is, the processing corresponding to the road curvature information acquisition means, the road map data of a point which is in front of the current position X by a predetermined distance along the road on which the vehicle is running (150 m in this case) is acquired from the storage device 441 of the navigation device 44.

At subsequent Step S62, it is judged whether or not the point 150 m ahead is a curved road end point Pi based on the road map data acquired at Step S61. If negative judgment is made at Step S62, the routine in FIG. 4 is terminated, and the routine advances to Step S70 in FIG. 2.

On the other hand, if positive judgment is made at Step S62, the processing advances to Step S63, that is, the processing corresponding to the control start point determination means. At Step S63, a control start point Ps is determined based on the curved road end point Pi. The control start point Ps refers to a point the vehicle 7 reaches the above-described curved road end point Pi after a time period which has been set in advance (three seconds later in this case), and it is determined according to the following manner. Specifically, the vehicle velocity V acquired at Step S10 in FIG. 2 is used, and the point which is closer to the vehicle than the curved road end point Pi by VX3 (m) is determined as the control start point Ps.

At subsequent Step 564, the target swivel angle α2 is calculated by substituting the vehicle velocity V represented by the vehicle velocity signal Sv and the curvature R contained in the road map data acquired at Step S61 to Equation (2) as described above.

The sub routine in FIG. 5 for executing the advance swivel control will now be described. In FIG. 5, at Step S71, it is judged whether or not the absolute value of the steering angle ω represented by the steering angle signal Sω acquired at Step S20 in FIG. 2 is equal to or less than a steering angle swivel switch angle C which has been set in advance to a value close to 0. If negative judgment is made at Step S71, the sub routine is terminated and the routine advances to Step S80 in FIG. 2. On the other hand, if positive judgment is made, the routine advances to Step S72.

At Step S72, it is judged whether or not the vehicle 7 has reached the control start point Ps determined at Step S63 in FIG. 4 based on the current position information acquired at Step S30 in FIG. 2. If the vehicle 7 has not reached the control start point Ps, or if the control start point Ps has not been determined, negative judgment is made. If negative judgment is made, the sub routine is terminated and the routine advances to Step S80 in FIG. 2. On the other hand, if positive judgment is made, the routine advances to Step S73.

At Step S73, the signal of the image in front of the vehicle acquired at Step S40 in FIG. 2 is analyzed by a known image analysis method, and it is judged whether or not an oncoming vehicle can be detected within the image. For example, if the headlights or the vehicle profile line of an oncoming vehicle can be detected by the analysis, it is judged that an oncoming vehicle can be detected. If an oncoming vehicle cannot be detected, negative judgment is made and Step S75 is directly executed. On the other hand, if an oncoming vehicle is detected, the routine advances to Step S74. Note that detection of an oncoming vehicle may be made for all ranges within the image, but the detection range may also be limited to be within a predetermined distance from the vehicle itself. In a case where the detection range is to be limited, the detection range may be changed based on the vehicle velocity V. For example, the detection range may be limited to a range in which the distance from the own vehicle is TxV (where, T denotes the light distribution point determination time and V denotes the vehicle velocity) or less.

At Step S74, it is judged whether or not the direction in which the oncoming vehicle is positioned is a swivel direction. In the case of a road on which a vehicle runs on the left road lane, the oncoming vehicle is positioned in the swivel direction in the right-hand curve, and on the other hand, the oncoming vehicle is positioned in the direction opposite to the swivel direction in the left-hand curve. In the case of a road on which a vehicle runs on the right road lane, the situation is totally the opposite. Accordingly, judgment at Step S74 is made based on the curvature direction contained in the road map data acquired at Step S61 in FIG. 4. Note that Steps S73 to S74 are the processing corresponding to the oncoming vehicle judgment means.

If negative judgment is made at Step S74 the routine advances to Step S75, and if positive judgment is made the routine advances to Step S76. At Step S75, the actual swivel angle α is increased to the target swivel angle α2 calculated at Step S64 in FIG. 4 by a predetermined unit angle by driving the driving mechanism 3. Note that the predetermined unit angle has been set smaller enough than the average target swivel angle α₂.

At Step S76, it is judged whether or not the actual swivel angle α is within the limit angle range which has been set in advance. The above-described limit angle range refers to the range of the swivel angle at which the headlights 2 of the own vehicle does not dazzle the driver of the oncoming vehicle even if swivel control is executed, and the limit angle range has been set in advance based on experiments or the like. For example, the limit angle range is set to ±3 to 5° or less.

If positive judgment is made at Step S76, in other words, if the swivel angle α has not exceeded the limit angle range, the routine advances to Step S77. At Step S77, the swivel angle α is increased toward the upper limit angle α_{TH} of the limit angle range by a predetermined unit angle by driving the driving mechanism 3.

On the other hand, if negative judgment is made at Step S76, in other words, if the swivel angle a has exceeded the limit angle range, the routine advances to Step S78. At Step S78, the swivel angle α is returned to the upper limit angle α_{TH} of the limit angle range by driving the driving mechanism 3.

The sub routine in FIG. 6 for executing the steering angle swivel control will now be described. In FIG. 6, at Step S81, it is judged whether or not the absolute value of the steering angle ω represented by the steering angle signal Sω acquired at Step S20 in FIG. 2 is larger than the above-described steering angle swivel switch angle C. If positive judgment is made, it can be judged that steering operation has been performed. Accordingly, Step S81 is the processing corresponding to the turning judgment means.

If negative judgment is made at Step S81, the sub routine is terminated. On the other hand, if positive judgment is made, the routine advances to Step S82. Steps S82, S83 and Steps S85 to S87 are the processing same as Steps S73, S74, S76 to S78 in FIG. 5, respectively.

In other words, also in the steering angle swivel control, it is judged whether or not an oncoming vehicle is present (S82), and if an oncoming vehicle is present it is judged whether or not the oncoming vehicle is positioned in the swivel direction (S83). Steps S82 to S83 also correspond to the oncoming vehicle judgment means. If the oncoming vehicle is positioned in the swivel direction, it is further judged whether or not the swivel angle α is within the limit angle range (S85). If the swivel angle α is still within the limit angle range, the swivel angle α is gradually changed to the upper limit angle α_{TH} of the limit angle range (S86), and if the swivel angle α exceeds the limit angle range, the swivel angle α is returned to the upper limit angle α_{TH} (S87).

If negative judgment is made at Step S82, or if negative judgment is made at Step S83 although positive judgment is made at Step S82, the routine advances to Step S84. At Step S84, the swivel angle α is increased toward the target swivel angle α₁ calculated at Step S52 in FIG. 3 by a predetermined unit angle by driving the driving mechanism 3.

According to the present embodiment as described hereinabove, in a case where it is judged that an oncoming vehicle is present on the road lane to which the headlights 2 are swiveled at Steps S73 to S74 in FIG. 5 or Steps S82 to S84 in FIG. 6, the swivel angle α is limited to within the limit angle range.

Specifically, in a case where it is judged that an oncoming vehicle is present in the swivel direction and if the swivel angle α has exceeded the limit angle range (i.e., negative judgment at Step S76 or S85), the swivel angle α is returned to the upper limit angle α_{TH}. On the other hand, in a case where it is judged that an oncoming vehicle is present in the swivel direction and if the swivel angle α is still within the limit angle range (i.e., positive judgment is made at Step S76 or S85), the range in which the swivel angle α can be changed is limited up to the upper limit angle α_{TH}. This prevents the driver of the oncoming vehicle from being dazzled.

In addition, in the present embodiment, the processing shown in FIG. 2 is executed repeatedly at a predetermined cycle. Accordingly, even when the swivel angle α has been limited based on the judgment that an oncoming vehicle is present, if it is no longer judged that an oncoming vehicle is present, control of the swivel angle α toward the target swivel angle α₁ or α₂ is initiated. Accordingly, the present embodiment enables making the illumination range of the headlights 2 closer to the direction of the line of sight of the driver, while preventing dazzling the driver of the oncoming vehicle.

The embodiment of the present invention has been described hereinabove, but the present invention is not limited to the embodiment as described above and the following embodiments are also included in the technical scope of the present invention. Furthermore, other than the embodiments to be described below, various modifications may be embodied within the scope of the invention as long as the modifications do not deviate from the summary of the invention.

For example, in the above-described embodiment, judgment on whether or not an oncoming vehicle is present is made also in the steering angle swivel control. If it is judged that an oncoming vehicle is present, the swivel angle α has been limited within the limit angle range. However, in the steering angle swivel control, judgment on whether or not an oncoming vehicle is present may not be made. Instead, control of the swivel angle α may be executed regardless of whether or not an oncoming vehicle is present.

In addition, in the above-described embodiment, judgment on whether or not an oncoming vehicle is present is made based on the signal from the in-vehicle camera 6. However, the means for judging whether or not an oncoming vehicle is present is not limited to this. For example, in a case where a radar device which emits a transmitted wave (millimeter wave or laser beam) toward the front of the vehicle and which receives the reflected wave of the transmitted wave is installed, the signal of the reflected wave may be acquired from the radar device and judgment on whether or not an oncoming vehicle is present may be made based on the signal of the reflected wave.

In addition, in the above-described embodiment, in a case where it is judged that an oncoming vehicle is present, the swivel angle α is controlled to the upper limit angle α_{TH} of the limit angle range. Instead, the swivel angle α may be set to 0 degree in a case where it is judged that an oncoming vehicle is present.

Alternatively, judgment may be made on whether or not the road on which the vehicle is running is a one-way road. If it is judged that the vehicle is running on a one-way road, judgment on whether or not an oncoming vehicle is present may not be made. The judgment of whether the road is a one-way road may be made using road map data, road traffic signs may be judged from the image.

In addition, in the above-described embodiment, the control start point Ps is determined based on the vehicle velocity V. Alternatively, a point closer to the own vehicle from the curved road end point Pi by a distance which has been set in advance may be set to the control start point Ps.

What is claimed is:

1. An apparatus for controlling a swivel angle of headlights mounted on a vehicle, wherein the swivel angle of the lights is changeable in a lateral direction of the vehicle, the apparatus comprising:
a driving mechanism that changes the swivel angle of the headlights in the lateral direction of the vehicle;
road curvature information acquisition means for acquiring road curvature information on a curvature of a road in front of a vehicle;
swivel control means for controlling the driving mechanism based on the road curvature information acquired by the road curvature information acquisition means;
oncoming vehicle judgment means for judging whether or not an oncoming vehicle is present; and
swivel angle limit means for limiting the swivel angle within a predetermined limit angle range which prevents a driver of the oncoming vehicle from being dazzled, in a case where it is judged by the oncoming vehicle judgment means that the oncoming vehicle is present on a road lane to which the headlights are swiveled.

2. The apparatus according to claim 1, further comprising:
position information acquisition means for acquiring current position information which corresponds to a current position of the vehicle,
wherein the road curvature information acquisition means acquires road map data of a road ahead based on the current position information as road curvature information, and
the apparatus further comprising:
control start point determination means for determining a control start point to a point which is closer to the vehicle than a curved road which is positioned in front of the vehicle based on the current position information and the road map data of the road ahead,
wherein the swivel control means executes an advance swivel control for controlling the swivel angle toward a target swivel angle which is determined based on a shape of the curved road ahead based on the fact that the current position of the vehicle has reached the control start point, and
the swivel angle limit means limits the swivel angle in the advance swivel control within the limit angle range, in a case where it is judged by the oncoming vehicle judgment means that an oncoming vehicle is present on the road lane to which the headlights are swiveled.

3. The apparatus according to claim 2, wherein the road curvature information acquisition means acquires as road curvature information a steering angle signal which corresponds to the steering angle of the vehicle,
the apparatus further comprising:
vehicle velocity signal acquisition means for acquiring a vehicle velocity signal which corresponds to a vehicle velocity of the vehicle; and
turning judgment means for judging whether or not steering operation has been performed based on the steering angle signal,
wherein the swivel control means executes a steering angle swivel control for controlling the swivel angle toward the target swivel angle which is determined based on the steering angle and the vehicle velocity based on the fact that it is judged by the turning judgment means that steering operation has been performed, and
the swivel angle limit means limits the swivel angle in the steering angle swivel control within the limit angle range, in a case where it is judged by the oncoming vehicle judgment means that the oncoming vehicle is present on the road lane to which the headlights are swiveled.

4. The apparatus according to claim 3, wherein the swivel angle limit means returns the swivel angle to within the limit angle range, in the state where the swivel angle is within the limit angle range or is larger and in a case where it is judged by the oncoming vehicle judgment means that an oncoming vehicle is present.

5. The apparatus according to claim 4, wherein the swivel angle limit means gradually changes the swivel angle to an upper limit angle of the limit angle range in the state where the swivel control means is gradually changing the swivel angle toward the target swivel angle which exceeds the limit angle range and in a case where the swivel angle thereof is within the limit angle range, even in a case where it is judged by the oncoming vehicle judgment means that an oncoming vehicle is present.

6. The apparatus according to claim 5, wherein the swivel angle 15 limit means gradually changes the swivel angle toward the target swivel angle in the state where the swivel angle is limited within the limit angle range, in a case where it is no longer judged by the oncoming vehicle judgment means that an oncoming vehicle is present.

7. The apparatus according to claim 6, wherein the oncoming vehicle judgment means acquires an image from a camera installed in the vehicle and which picks up an image of a front of the vehicle, and makes a judgment on whether or not the oncoming vehicle is present by analyzing the image.

8. The apparatus according to claim 6, wherein the oncoming vehicle judgment means acquires a signal of a reflected wave from a radar device installed in the vehicle, which emits a transmitted wave to the front of the vehicle, and which receives a reflected wave of the transmitted wave, and judges whether or not the oncoming vehicle is present based on the signal of the reflected wave.

9. The apparatus according to claim 1, wherein the road curvature information acquisition means acquires as road curvature information a steering angle signal which corresponds to the steering angle of the vehicle,
the apparatus further comprising:
vehicle velocity signal acquisition means for acquiring a vehicle velocity signal which corresponds to a vehicle velocity of the vehicle; and
turning judgment means for judging whether or not steering operation has been performed based on the steering angle signal,
wherein the swivel control means executes a steering angle swivel control for controlling the swivel angle toward the target swivel angle which is determined based on the steering angle and the vehicle velocity based on the fact that it is judged by the turning judgment means that steering operation has been performed, and
the swivel angle limit means limits the swivel angle in the steering angle swivel control within the limit angle range, in a case where it is judged by the oncoming vehicle judgment means that the oncoming vehicle is present on the road lane to which the headlights are swiveled.

10. The apparatus according to claim 1, wherein the swivel angle limit means returns the swivel angle to within the limit angle range, in the state where the swivel angle is within the limit angle range or is larger and in a case where it is judged by the oncoming vehicle judgment means that an oncoming vehicle is present.

11. The apparatus according to claim 1, wherein the swivel angle limit means gradually changes the swivel angle to an upper limit angle of the limit angle range in the state where the swivel control means is gradually changing the swivel angle toward the target swivel angle which exceeds the limit angle range and in a case where the swivel angle thereof is within the limit angle range, even in a case where it is judged by the oncoming vehicle judgment means that an oncoming vehicle is present.

12. The apparatus according to claim 1, wherein the swivel angle limit means gradually changes the swivel angle toward the target swivel angle in the state where the swivel angle is limited within the limit angle range, in a case where it is no longer judged by the oncoming vehicle judgment means that an oncoming vehicle is present.

13. The apparatus according to claim 1, wherein the oncoming vehicle judgment means acquires an image from a camera installed in the vehicle and which picks up an image of a front of the vehicle, and makes a judgment on whether or not the oncoming vehicle is present by analyzing the image.

14. The apparatus according to claim 1, wherein the oncoming vehicle judgment means acquires a signal of a reflected wave from a radar device installed in the vehicle, which emits a transmitted wave to the front of the vehicle, and which receives a reflected wave of the transmitted wave, and judges whether or not the oncoming vehicle is present based on the signal of the reflected wave.

15. An apparatus for controlling a swivel angle of headlight mounted on a vehicle, wherein the swivel angle of the lights is changeable in a lateral direction of the vehicle, the apparatus comprising:
a driving mechanism which rotationally changes the swivel angle of the headlights in the lateral direction of the vehicle;
a road curvature information acquisition block that acquires road curvature information on a curvature of a road in front of a vehicle;
a swivel control block that controls the driving mechanism based on the road curvature information acquired by the road curvature information acquisition means;
an oncoming vehicle judgment block that judges whether or not an oncoming vehicle is present; and
a swivel angle limit block that limits the swivel angle within a predetermined limit angle range which prevents a driver of the oncoming vehicle from being dazzled, in a case where it is judged by the oncoming vehicle judgment means that the oncoming vehicle is present on a road lane to which the headlights are swiveled.

16. The apparatus according to claim 1, further comprising:
a position information acquisition block that acquires current position information which corresponds to a current position of the vehicle,
wherein the road curvature information acquisition block acquires road map data of a road ahead based on the current position information as road curvature information, and
the apparatus further comprising:
a control start point determination block that determines a control start point to a point which is closer to the vehicle than a curved road which is positioned in front of the vehicle based on the current position information and the road map data of the road ahead,
wherein the swivel control block executes an advance swivel control for controlling the swivel angle toward a target swivel angle which is determined based on a shape of the curved road ahead based on the fact that the current position of the vehicle has reached the control start point, and
the swivel angle limit block limits the swivel angle in the advance swivel control within the limit angle range, in a case where it is judged by the oncoming vehicle judgment block that an oncoming vehicle is present on the road lane to which the headlights are swiveled.

17. The apparatus according to claim 16, wherein the road curvature information acquisition block acquires as the road curvature information a steering angle signal which corresponds to the steering angle of the vehicle,
the apparatus further comprising:
a vehicle velocity signal acquisition block that acquires a vehicle velocity signal which corresponds to a vehicle velocity of the vehicle; and
a turning judgment block that judges whether or not steering operation has been performed based on the steering angle signal,
wherein the swivel control block executes a steering angle swivel control for controlling the swivel angle toward the target swivel angle lo determined based on the steering angle and the vehicle velocity based on the fact that it is judged by the turning judgment block that steering operation has been performed, and
the swivel angle limit block limits the swivel angle in the steering angle swivel control within the limit angle range, in a case where it is judged by the oncoming vehicle judgment block that the oncoming vehicle is present on the road lane to which the headlights are swiveled.

18. The apparatus according to claim 17, wherein the swivel angle limit block returns the swivel angle to within the limit angle range, in the state where the swivel angle is within the limit angle range or is larger and in a case where it is judged by the oncoming vehicle judgment block that an oncoming vehicle is present.

19. The apparatus according to claim 18, wherein the swivel angle limit block gradually changes the swivel angle to an upper limit angle of the limit angle range in the state where the swivel control block is gradually changing the swivel angle toward the target swivel angle which exceeds the limit angle range and in a case where the swivel angle thereof is within the limit angle range, even in a case where it is judged by the oncoming vehicle judgment block that an oncoming vehicle is present.

20. A method of controlling a swivel angle of headlight mounted on a vehicle, wherein the swivel angle of the lights is changeable in a lateral direction of the vehicle, the method comprising steps of:
acquiring road curvature information on a curvature of a road in front of a vehicle;
controlling a driving mechanism which rotationally changes the swivel angle of the headlights based on the road curvature information acquired by the road curvature information acquisition means;
judging whether or not an oncoming vehicle is present; and
limiting the swivel angle within a predetermined limit angle range which prevents a driver of the oncoming vehicle from being dazzled, in a case where it is judged that the oncoming vehicle is present on a road lane to which the headlights are swiveled.
